(19) United States
(12) Patent Application Publication
(10) Pub. No.: US 2015/0120707 A1
(43) Pub. Date: Apr. 30, 2015

(54) METHOD AND APPARATUS FOR PERFORMING IMAGE-BASED SEARCHES

(71) Applicant: Samsung Electronics Co., Ltd., Gyeonggi-do (KR)

(72) Inventors: Shegufta Bakht AHSAN, Dhaka (BD); Syeda Persia AZIZ, Dhaka (BD); A.S.M. Hossain BARI, Bogra (BD)

(21) Appl. No.: 14/528,031

(22) Filed: Oct. 30, 2014

(30) Foreign Application Priority Data
Oct. 31, 2013 (KR) 10-2013-0131320

(51) Int. Cl. G06F 17/30

(52) U.S. Cl. CPC G06F 17/30256; G06F 17/30837
USPC 707/722

(57) ABSTRACT

A method is provided including: transmitting, by an electronic device, an image to a server, the image being part of a video content that is currently output by the electronic device; receiving, from the server, a first plurality of analysis results that are generated by the server based on the image, each analysis result including a respective search query that is generated by the server and one or more search results retrieved by the server based on the respective search query; displaying a second plurality of identifiers, each one of the second plurality of identifiers identifying a different one of the first plurality of analysis results.

### CLAIM OF PRIORITY

This application claims the benefit under 35 U.S.C. §119(a) of a Korean patent application filed on Oct. 31, 2013 in the Korean Intellectual Property Office and assigned Serial No. 10-2013-0131320, the entire disclosure of which is hereby incorporated by reference.

### TECHNICAL FIELD

The present disclosure relates to electronic devices in general, and more particularly to a method and apparatus for performing image-based searches.

### BACKGROUND

Television (TV) is a representative electronic device for the transmission of integrated audible and visible content. A traditional TV has, however, a limitation of unidirectional transmission in which a viewer unilaterally receives such content from a broadcasting station. Although any partial bidirectional service such as a cable TV or IPTV (Internet Protocol TV) has been recently developed, complete bidirectionality similar to the level of PC or smartphone has been not reached yet.

In order to obviate this limitation, a smart TV which allows a bidirectional communication between a user and a TV has been now developed. With the growth of digital convergence, a smart TV comes to have the ability to perform a function on the level of PC or smartphone by having therein an operating system and a processor. For example, a recent smart TV has an internet access function and allows the download of applications for performing various functions such as a web surfing, a VOD (Video On Demand) play, an SNS (Social Networking Service), a game, and the like.

In this smart TV, a user who desires to obtain information about an object in content being played has to directly enter a search query in the form of text. This often causes inconvenience to a user. Further, since a user who enters a search query is required to know or estimate certain information about an object or content, this often causes the difficulty of search.

### SUMMARY

The present disclosure addresses this need. According to one aspect of the disclosure, a method is provided comprising: transmitting, by an electronic device, an image to a server, the image being part of a video content that is currently output by the electronic device; receiving, from the server, at least one of analysis results that are generated by the server based on the image, each analysis result including a respective search query that is generated by the server and one or more search results retrieved by the server based on the respective search query; displaying the received at least one analysis result.

According to another aspect of the disclosure, an electronic device is provided comprising a control unit configured to: transmit an image to a server, the image being part of a video content that is currently output by the electronic device; receive at least one of analysis results that are generated by the server based on the image, each analysis result including a respective search query that is generated by the server and one or more search results retrieved by the server based on the respective search query; and display the received at least one analysis result.

According to yet another aspect of the disclosure, a server is provided comprising a control unit configured to: receive an image from an electronic device; extract at least one object from an acquired image; compare the object with stored database of objects and retrieve, from the database, information that matches the object; create an analysis result corresponding to the object; and transmit the analysis result to the electronic device.

According to yet another aspect of the disclosure, an electronic device is provided comprising a control unit configured to: transmit an image to a server, the image being part of a video content that is currently output by the electronic device; receive an analysis result that is generated by the server based on the image, the analysis result including a search query that is generated by the server and one or more search results retrieved by the server based on the search query; display the analysis result.

### BRIEF DESCRIPTION OF THE DRAWINGS

FIG. 1 is a block diagram illustrating of an example of an electronic device, according to aspects of the disclosure;

FIG. 2 is a flowchart of an example of a process, according to aspects of the disclosure;

FIG. 3 is a flowchart of an example of a process, according to aspects of the disclosure;

FIG. 4A and FIG. 4B are flowcharts of examples of processes for revising or supplementing analysis results, in accordance with aspects of the disclosure; and

FIG. 5A, FIG. 5B and FIG. 5C are diagrams of an example of a user interface, according to aspects of the disclosure.

### DETAILED DESCRIPTION

The following description with reference to the accompanying drawings is provided to assist in a comprehensive understanding of various aspects of the present disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustrative purposes only and not for the purpose of limiting the present disclosure as defined by the appended claims and their equivalents.

It is to be understood that the singular forms “a”, “an”, and “the” include plural referents unless the context clearly dictates otherwise. Thus, for example, reference to “an object” includes reference to one or more of such objects.

An electronic device according to the present disclosure may involve a communication function. For example, an electronic device may be a smartphone, a tablet PC (Personal Computer), a mobile phone, a video phone, an e-book reader, a desktop PC, a laptop PC, a netbook computer, a PDA (Personal Digital Assistant), a PMP (Portable Multimedia Player), an MP3 player, a portable medical device, a digital camera, or a wearable device (e.g., an HMD (Head-Mounted Device) such as electronic glasses, electronic clothes, an electronic bracelet, an electronic necklace, an electronic appcessory, or a smart watch).

According to some embodiments, an electronic device may be a smart home appliance that involves a communication function. For example, an electronic device may be a television set (e.g., a Smart TV), a DVD (Digital Video Disk) player, audio equipment, a refrigerator, an air conditioner, a vacuum cleaner, an oven, a microwave, a washing machine, an air cleaner, a set-top box, a TV box (e.g., Samsung HomeSync™, Apple TV™, Google TV™, etc.), a game console, an electronic dictionary, an electronic key, a camcorder, or an electronic picture frame.

According to some embodiments, an electronic device may be a medical device (e.g., MRA (Magnetic Resonance Angiography), MRI (Magnetic Resonance Imaging), CT (Computed Tomography), ultrasonography, etc.), a navigation device, a GPS (Global Positioning System) receiver, an EDR (Event Data Recorder), an FDR (Flight Data Recorder), a car infotainment device, electronic equipment for ship (e.g., a marine navigation system, a gyrocompass, etc.), avionics, security equipment, or an industrial or home robot.

According to some embodiments, an electronic device may be furniture or part of a building or construction having a communication function, an electronic board, an electronic signature receiving device, a projector, or various measuring instruments (e.g., a water meter, an electric meter, a gas meter, a wave meter, etc.). An electronic device disclosed herein may be one of the above-mentioned devices or any combination thereof. As well understood by those skilled in the art, the above-mentioned electronic devices are exemplary only and not to be considered as a limitation of this disclosure.

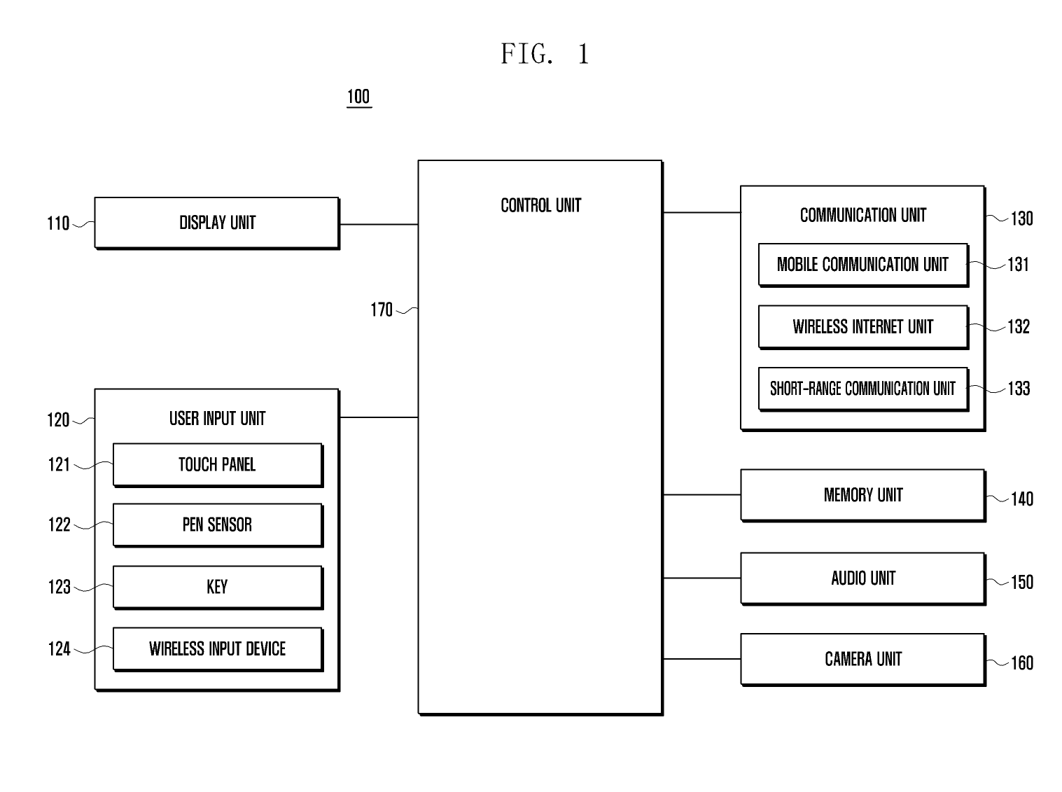

FIG. 1 is a block diagram illustrating of an example of an electronic device, according to aspects of the disclosure.

Although the configuration of the electronic device 100 in this embodiment can be favorably applied to a smart TV, this is exemplary only and not to be considered as a limitation. Alternatively, the configuration of the electronic device 100 may be applied to other various devices, e.g., a smartphone, a tablet PC, a hand-held PC, a laptop PC, a PMP (Portable Multimedia Player), a PDA (Personal Digital Assistant), and a wearable device such as a wrist watch or an HMD (Head-Mounted Display).

Referring to FIG. 1, the electronic device 100 may include, but not limited to, a display unit 110, a user input unit 120, a communication unit 130, a memory unit 140, a camera unit 150, an audio unit 160, and a control unit 170.

The display unit 110 may perform a function to visually offer images or data to a user. The display unit 110 may include a display panel, which may be formed of, for example, LCD (Liquid Crystal Display), AMOLED (Active Matrix Light Emitted Diode), or the like. The display unit 110 may further include a controller configured to control such a display panel. The display panel may be realized in a flexible, transparent or wearable form. The display unit 110 may be what is called an in-cell display that has a user input function (e.g., a touch function).

Additionally, the display unit 110 may be provided in the form of a touch screen by being integrated with a touch panel 121. For example, the touch screen may be designed as an integrated module in which the display panel and the touch panel are combined with each other as a stack structure.

The user input unit 120 may receive various commands from a user. The user input unit 120 may include, for example, but not limited to, at least one of the touch panel 121, a pen sensor 122, a key 123, and a wireless input device 124.

The touch panel 121 may recognize a user's touch input through well-known sensing technique such as a capacitive type, a resistive type, an infrared type, an ultrasonic type, or the like. The touch panel 121 may further include therein a controller (not shown). Meanwhile, in case of a capacitive type, the touch panel 121 may have a proximity sensing capability in addition to a touch detecting capability. Additionally, the touch panel 121 may further include therein a tactile layer. In this case, the touch panel 121 may offer a tactile feedback to a user.

The pen sensor 122 may be formed of, e.g., special sheet for recognizing a pen in the same way as receiving a user's touch input.

The key 123 may have a mechanical key and/or a touch key. The mechanical key may include, but not limited to, at least one of a power button disposed on the lateral side of the electronic device 100 and used to turn on or off the electronic device 100, a volume button disposed on the lateral side of the electronic device 100 and used to adjust a volume, and a home button disposed on the front side of the electronic device 100 and used to invoke a home screen. The touch key may include, but not limited to, at least one of a menu key disposed on the front side of the electronic device 100 and used to offer a menu associated with currently displayed content, and a return key disposed on the front side of the electronic device 100 and used to return to the previous screen.

The wireless input device 124 may be connected with the communication unit 130 and deliver a user's input signal to the electronic device 100 through the communication unit 130. For example, the wireless input device 124 may be a remote controller, a keyboard, a mouse, an input pad, a separate touch screen, or a wearable device, all of which have a wireless communication function.

The communication unit 130 may include therein, but not limited to, at least one of a mobile communication unit 131, a wireless internet unit 132, and a short-range communication unit 133.

The mobile communication unit 131 transmits or receives a wireless signal to or from a base station, any other device, and/or a server in a mobile communication network. Such a wireless signal may include a voice call signal, a video call signal, or various types of data associated with a text or multimedia message.

The wireless internet unit 132 performs a function of access to a wireless internet. Wireless internet technique may employ WLAN (Wireless Local Area Network, also known as Wi-Fi), Wibro (Wireless broadband), WIMAX (World Interoperability for Microwave Access), HSDPA (High Speed Downlink Packet Access), and the like.

The short-range communication unit 133 performs a function of a short-range communication. Short-range communication technique may employ Bluetooth, RFID (Radio Frequency Identification), IrDA (Infrared Data Association), UWB (Ultra WideBand), ZigBee, and the like.

Additionally, the communication unit 130 may further include a network interface (e.g., LAN card) or modem for connecting the electronic device 100 with a network (e.g., Internet, LAN (Local Area Network), WAN (Wide Area Network), a telecommunication network, a cellular network, a satellite network, POTS (Plain Old Telephone Service), etc.). According to aspects of the disclosure, under the control of the control unit 170, the communication unit 130 may transmit, to the memory unit 140, location information, time information, and/or weather information obtained from a specific server or any other electronic device, or may create tag information by using such obtained information.

The memory unit 140 may include at least one of an internal memory and an external memory.

The internal memory may include at least one of a volatile memory (e.g., DRAM (Dynamic Random Access Memory), SRAM (Static RAM), SDRAM (Synchronous DRAM), etc.), a nonvolatile memory (e.g., OTPROM (One-Time Programmable Read Only Memory), EPROM (Erasable and Programmable ROM), EEPROM (Electrically Erasable and Programmable ROM), a mask ROM, a flash ROM, etc.), a hard disk drive (HDD), and a solid state drive (SSD). According to aspects of the disclosure, the control unit 170 may process commands or data received from the nonvolatile memory or from any other element by loading them onto the volatile memory. Also, the control unit 170 may preserve, in the nonvolatile memory, data created or received from any other element.

The external memory may include at least one of CF (Compact Flash), SD (Secure Digital), Micro-SD, Mini-SD, xD (extreme Digital), and a memory stick.

The memory unit 140 may store therein an operating system for controlling resources of the electronic device 100, a program for the operation of an application, and the like. The operating system may include a kernel, a middleware, an API (Application Programming Interface), and the like. A well-known operating system such as Android, iOS, Windows, Symbian, Tizen, Ubuntu, or Bada may be used.

The kernel may include a resource manager for managing a system resource, and a device driver. The resource manager may be composed of, e.g., a control unit manager, a memory unit manager, a file system manager, etc., and may perform a function to control, allocate or retrieve a system resource. The device driver may control various elements of the electronic device 100 through access by software. For this, the device driver may be composed of an interface and individual driver modules provided by respective hardware manufacturers. The device driver may include, e.g., at least one of a display driver, a camera driver, a Bluetooth driver, a share memory driver, a USB driver, a keypad driver, a Wi-Fi driver, an audio driver, and an IPC (Inter-Process Communication) driver.

The middleware may be formed of a plurality of modules configured in advance to offer a particular function required in common by various applications. The middleware may offer a commonly required function through the API such that an application can effectively use limited system resource in the electronic device 100. The middleware may include, e.g., at least one of an application manager, a window manager, a multimedia manager, a resource manager, a power manager, a database manager, and a package manager. Additionally, the middleware may include at least one of a connectivity manager, a notification manager, a location manager, a graphic manager, and a security manager. Further, according to aspects of the disclosure, a runtime library or any other library module may be included. The runtime library is a library module used by a compiler to add a new function through a programming language while an application is running. For example, the runtime library may perform specific functions regarding input/output, memory management, arithmetic function, or the like. The middleware may create a new middleware module by combining various functions of the above internal element modules. Meanwhile, in order to provide a differentiated function, the middleware may offer a specialized module for each operating system.

The API is a set of API programming functions and may have different configurations depending on the operating system. For example, in case of Android or iOS, a single API set may be provided for each platform. In case of Tizen, two or more API sets may be provided.

An application may perform at least one particular function using a related program. Applications may be classified, e.g., into a preloaded application and a third-party application. For example, a home application for invoking a home screen, an SMS (Short Message Service) or MMS (Multimedia Message Service) application, an IM (Instant Message) application, a browser application, a camera application, an alarm application, an email application, a calendar application, a media player, an album application, a clock application, and the like may be used.

The memory unit 140 may store therein various kinds of data collected through the communication unit 130, the user input unit 120, the camera unit 150 and the audio unit 160. Further, the memory unit 140 may store therein tag information created using such collected data by the control unit 140.

The camera unit 150 may take a picture or record a video, and have one or more image sensors (e.g., a front lens and/or a rear lens), an ISP (Image Signal Processor), and/or a flash LED.

Meanwhile, the camera unit 150 may be formed to have at least part of the control unit 170. For example, the camera unit 150 may have functions to acquire an image, correct an image, extract a feature from an image, or the like. In this case, the camera unit 150 may be a functional module having a hardware module and a software module.

The audio unit 160 may perform conversion between an audio signal and an electric signal. For example, the audio unit 160 includes at least one of a speaker, a receiver, an earphone, and a microphone, and may perform conversion of an audio signal inputted or outputted.

The control unit 170 may drive an operating system and programs, control various hardware and software components connected thereto, and perform a processing of various data including multimedia data. The control unit 170 may include any suitable type of processing circuitry, such as a processor (e.g., an ARM-based processor, a SoC (System on Chip), GPU (Graphic Processing Unit), etc.), a Field-Programmable Gate Array (FPGA), or an Application-Specific Integrated Circuit (ASIC).

As discussed further below, the electronic device 100 may visually output (e.g., play), on the display unit 110, specific content stored in the memory unit 140 or received from any external entity. For example, such content outputted on the display unit 110 may be an image or a video.

The control unit 170 may acquire a particular image from of the content that is currently being output on the display unit 110. In some implementations, acquiring the image may include capturing an entire frame that is being currently displayed. Additionally or alternatively, in some implementations, capturing the image may include extracting only a portion of the frame that is being currently output.

For example, when a video is played on the display unit 110, a desired image (e.g., part of frames) may be captured from the video. Alternatively, when a certain image is displayed on the display unit 110, a desired part may be captured from the image. If a user desires to search for a specific image or object contained in the visible output of image or video, a user can manipulate the user input unit 120 to acquire a desired image from the visible output. When a command to acquire an image is received through the user input unit 120, the control unit 170 acquires a particular image from the visible output. For example, a user who is watching video content may desire to obtain information about a title of the content that is being played, an actor or actress, his or her films, a place where a given scene is set, a certain object shown in scene, or the like. Then a user may input a command in the user input unit 120 requesting the control unit 170 to provide information about the frame that is being displayed.

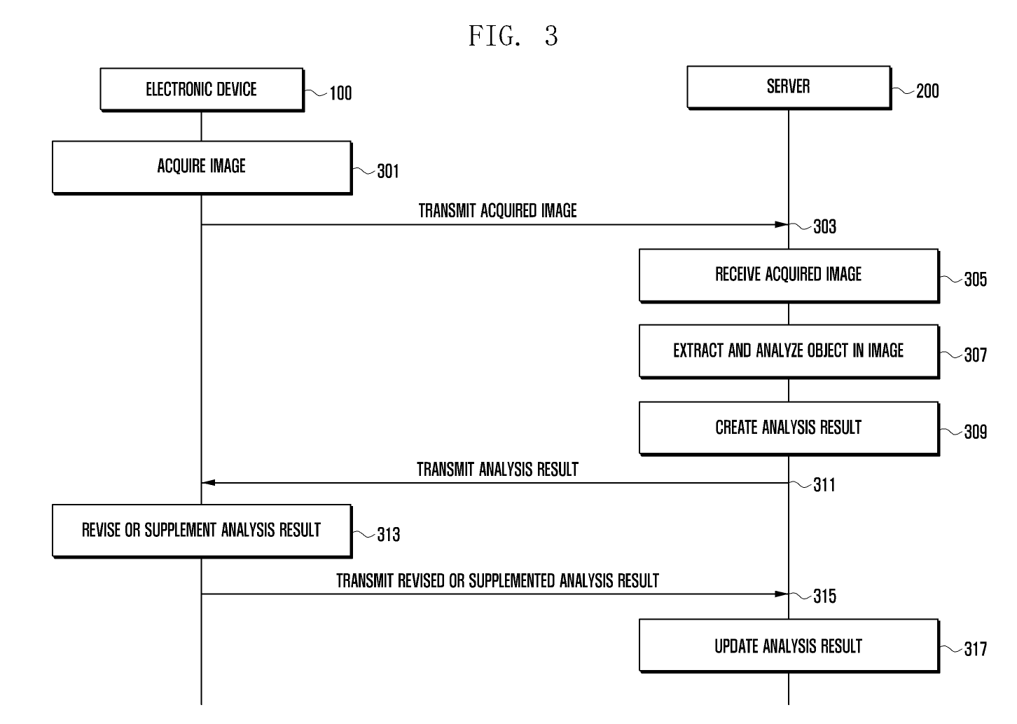

In response to the command, the control unit 170 may acquire at least a portion of the video frame that is currently displayed on the display unit 110 and transmit the acquired image (i.e., the frame or portion thereof) to a server (200 in FIG. 3) through the communication unit 130. The server 200 may analyze the received image, generate a query based on the received image, perform a search based on the query, obtain a response to the search, and transmit the query and the response, as an analysis result, to the electronic device 100.

In one aspect, the query may be generated by analyzing the acquired image. For example, the query may include a request to identify a title of the content that is being played, an actor or actress, one or more other films that the actor/actress has performed in, a place where the scene of which the image is part is set, a certain object shown in scene, or the like. Put simply, the query may include a request for any suitable type of information regarding the content of the frame (or portion thereof) that is submitted to the server.

The response to the query may be information obtained through a search based on the query. Therefore, the control unit 170 may receive an image analysis result from the server 200 through the communication unit 130. This analysis result may contain at least one query associated with the acquired image and at least one response to the query.

The control unit 170 may determine whether to display the analysis result received from the server 200 on the display unit 110. For example, the control unit 170 may control the display unit 110 to display thereon a user interface through which a user can select whether to display the analysis result. If a user selects no display of the analysis result, the control unit 170 may continue playing the video content without displaying the received analysis result on the display unit 110.

If a user selects a display of the analysis result, the control unit 170 may display the received analysis result on the display unit 110. As mentioned above, the displayed analysis result may contain at least one query associated with the acquired image and at least one response to the query.

A user may select one of such analysis results. Namely, in case one or more queries associated with the acquired image and one or more responses to such queries are displayed, a user can select one from the displayed queries and responses. Then the control unit 170 may display the selected analysis result on the display unit 110.

Additionally, the control unit 170 may determine whether the analysis result is revised or supplemented. If the analysis result fails to satisfy a user's expectation, a user may revise or supplement the analysis result. When there is any revision or supplement of the analysis result, the control unit 170 transmits such a revision or supplement of the analysis result to the server 200 through the communication unit 130.

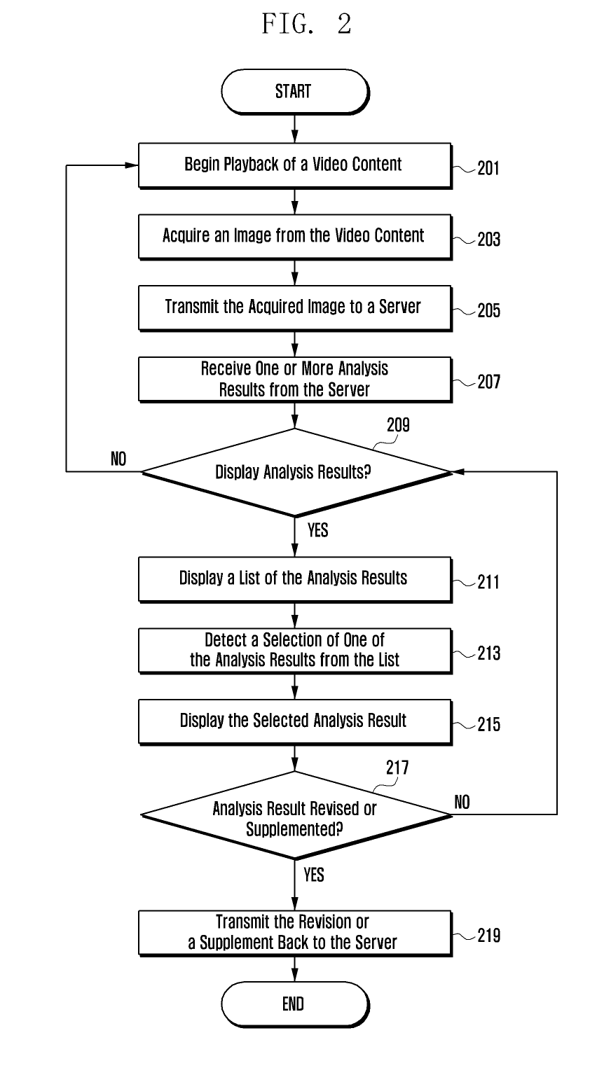

FIG. 2 is a flowchart of an example of a process, according to aspects of the disclosure. At step 201, the electronic device 100 may begin playback, on the display unit 110, of specific content (e.g., video content) stored in the memory unit 140 or received from any external entity (e.g., broadcast content). For example, this visible output may be an image or a video.

At step 203, the electronic device 100 may acquire a particular image from the content that is being played. The particular image may include a video frame that is currently being displayed, a portion of the frame that is currently being displayed, another frame, and/or a portion of the other frame. Thus, in some implementations, acquiring the particular image may include extracting a portion of a frame that is currently being displayed.

For example, when a video is played on the display unit 110, a desired image (e.g., part of a frame that is currently displayed when the user submits an instruction to acquire the image) may be captured from the video. For example, if a user desires to search for a specific image or object contained in the visible output of image or video, a user can enter an instruction, via the input unit 120, selecting a desired portion of a frame that is currently visible on the display unit 110. When a command to acquire an image is received through the user input unit 120, the electronic device 100 acquires a particular image from the visible output. For example, a user who watches a certain visible output of image or video may desire to obtain information about a title of the content that is being played, an actor or actress, his or her films, a scene place, an object shown in scene, or the like. Then a user enters an image acquiring command in the user input unit 120, and the electronic device 100 acquires a particular image from the visible output.

At step 205, the electronic device 100 may transmit the acquired image to the server (200 in FIG. 3). Then the server 200 may analyze the received image, generate a query based on the received image, perform a search based on the query (e.g., a database search), obtain one or more search results, and transmit the query and the search results, as an analysis result, to the electronic device 100. For example, and without limitation, the query may include a request to identify a title of the content that is being played, an actor or actress, one or more other films where the actor/actress has performed, a place where a scene is set, an object shown in scene, or the like. The response to the query may be information obtained through a search based on the query.

At step 207, the electronic device 100 may receive one or more analysis results from the server 200. Each of the analysis result may contain at least one query associated with the acquired image and one or more search results retrieved by the server based on the search query.

At step 209, the electronic device 100 may determine whether to display the analysis result received from the server 200 on the display unit 110. For example, the electronic device 100 may display, on the display unit 110, a user interface through which a user can select whether to display a list of the analysis results. If a user selects no display of the analysis results, the electronic device 100 may return to step 201 and continue playing the content without displaying the list of the received analysis results on the display unit 110.

If a user selects a display of the analysis result, at step 211 the electronic device 100 may display a list of the analysis results. In some implementations, the list may include a plurality of identifiers, each identifier corresponding to a different one of the analysis results received at step 207.

At step 213, the electronic device 100 may detect a selection of one of the identifiers in the list. For example a user can provide an input selecting a desired one of the displayed identifiers. Upon receiving the input, the electronic device 100 may process the input to recognize the user's selection and determine the analysis result that is identified by the identifier.

At step 215, the electronic device 100 may display the analysis result identified by the identifier on the display unit 110.

At step 217, the electronic device 100 may determine whether user input is received for revising or supplementing the analysis results. If the analysis result fails to satisfy a user's expectation, a user may revise or supplement the analysis result. If there is no revision or no supplement of the analysis result, the electronic device 100 may return to step 209. If there is any revision or supplement of the analysis result, the electronic device 100 transmits such a revision or supplement of the analysis result to the server 200 at step 219.

FIG. 3 is a flowchart of an example of a process, according to aspects of the disclosure. According to this example, the server 200 may include therein a communication unit (not shown) that transmits or receives the acquired image, the analysis result, and/or the revised or supplemented analysis result to or from the electronic device 100. Furthermore, the server 200 may also include therein a control unit (not shown) that extracts an object from the acquired image, analyzes information about the extracted object by comparing the extracted object with database about objects, and creates an analysis result about the object contained in and extracted from the acquired image. Also, the control unit of the server 200 may learn the revised or supplemented analysis result. This learning of the revised or supplemented analysis result may be to update an existing database containing information about the object according to the revised or supplemented analysis result. Further, whenever any acquired image is received from the electronic device 100, the control unit of the server 200 may monitor a user's preference about a specific object and apply such a preference to the analysis result.

At step 301, the electronic device 100 may start playback of video content, on the display unit 110. The content may include specific content stored in the memory unit 140 or received from any external entity (e.g., broadcast content). In addition, at step 301, the electronic device may also acquire a particular image from the video content. As noted above, the image may include a frame that is currently being displayed on the display unit 110, a portion of frame that is currently being displayed, another frame, and/or a portion of the other frame.

For example, when a video is played, the electronic device 100 captures a desired image (e.g., part of frames) from the video. Alternatively, when a certain image is displayed, the electronic device 100 captures a desired part from the image. If a user desires to search for a specific image or object contained in the visible output of image or video, a user can manipulate the electronic device 100 to acquire a desired image from the visible output. When a command to acquire an image is received through the user input unit 120, the electronic device 100 acquires a particular image from the visible output. For example, a user who watches a certain visible output of image or video may desire to obtain information about a title of the content that is being played, an actor or actress, his or her films, a scene place, a certain object shown in scene, or the like. Then a user enters an image acquiring command in the user input unit 120, and the electronic device 100 acquires a particular image from the visible output.

At step 303, the electronic device 100 transmits the acquired image to the server 200 through the communication unit 130.

At step 305, the server 200 receives the acquired image.

At step 307, the server 200 extracts a specific object from the acquired image and analyzes the extracted object. The object may include an image of any suitable type of physical object, such as an image of a person, an image of a building, etc. Therefore, at step 307, the server 200 may extract at least one object such as a person and a place, and analyze the extracted object by comparing the extracted object against a database of objects (e.g., a database of object signatures).

Then, at step 309, the server 200 may create an analysis result about the specific object contained in and extracted from the acquired image.

At step 311, the server 200 may transmit the created analysis result to the electronic device 100.

At step 313, the electronic device 100 determines whether the analysis result is revised or supplemented. If the analysis result fails to satisfy a user's expectation, a user may revise or supplement the analysis result.

At step 315, the electronic device 100 transmits the revised or supplemented analysis result to the server 200. Then, at step 317, the server 200 may update the current analysis result according to the received analysis result.

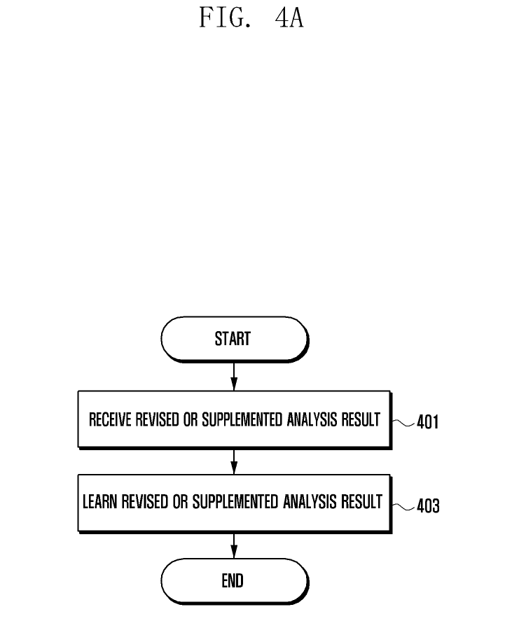

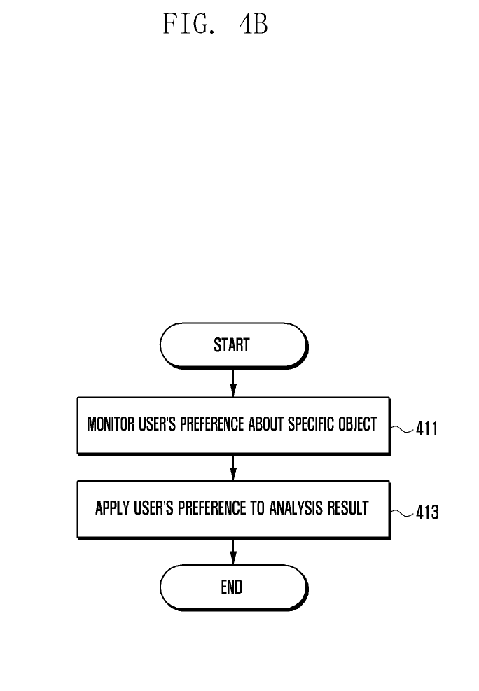

FIGS. 4A and 4B are flowcharts of examples of processes for revising or supplementing analysis results, in accordance with aspects of the disclosure.

Referring to FIG. 4A, at step 401, the server 200 receives any revised or supplemented analysis result from the electronic device 100. Then, at step 403, the server 200 learns the revised or supplemented analysis result. By way of example, the learning of the revised or supplemented analysis result may include updating the database from which the original analysis results were obtained in accordance with the revised or supplemented analysis result that is received from the electronic device 100.

Referring to FIG. 4B, at step 411, when any acquired image is received from the electronic device 100, the server 200 monitors a user's preference about a specific object contained in the acquired image. Then, at step 413, the server 200 may apply such a preference to the analysis result. Namely, based on a user's preference, the server 200 may create, revise or supplement the analysis result.

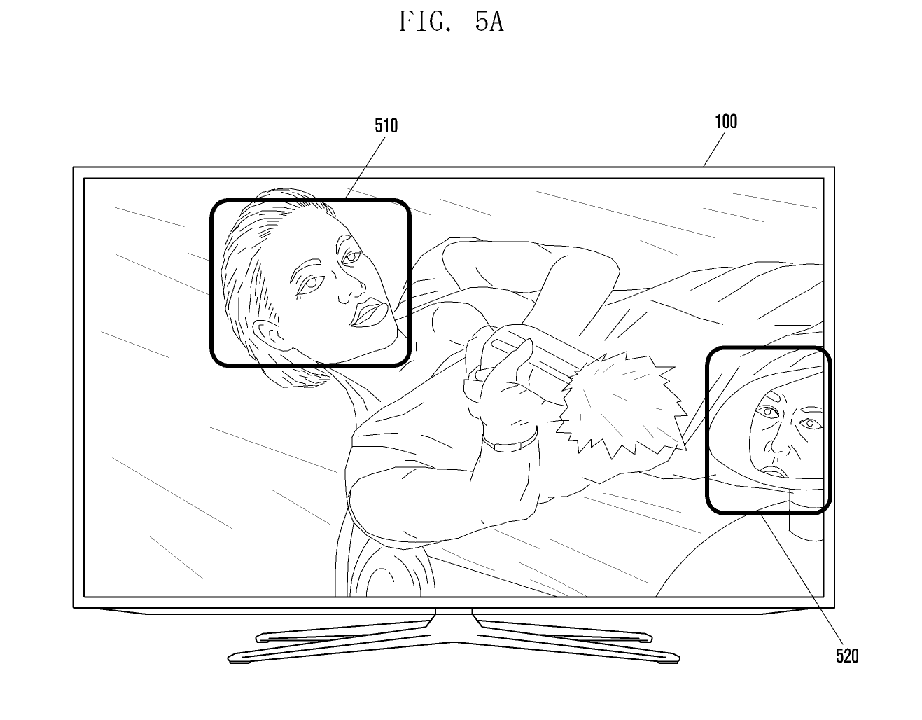

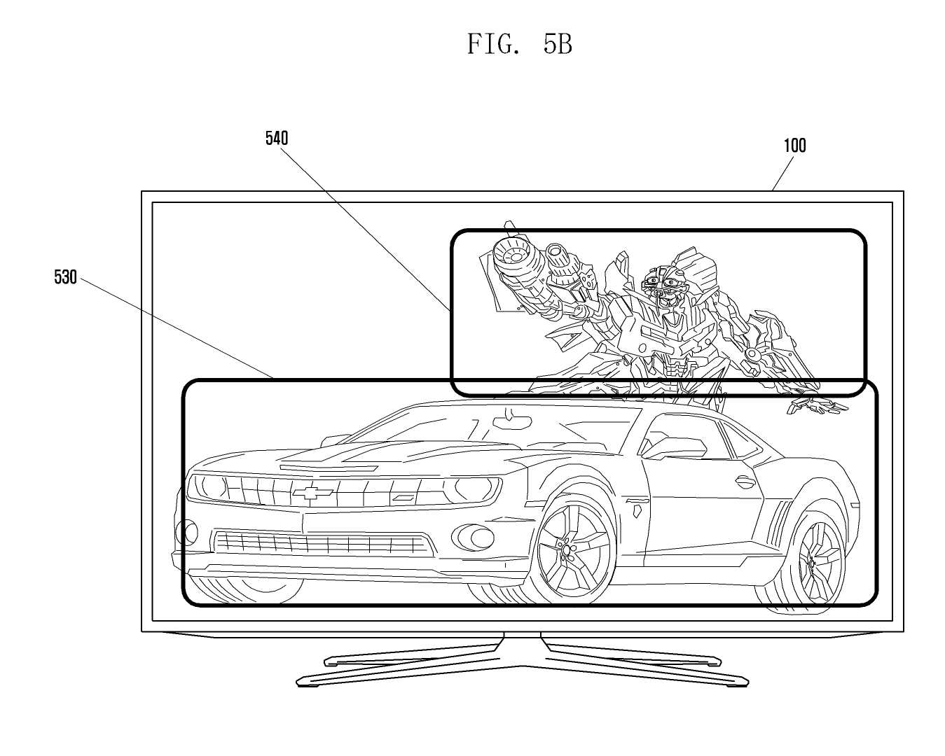

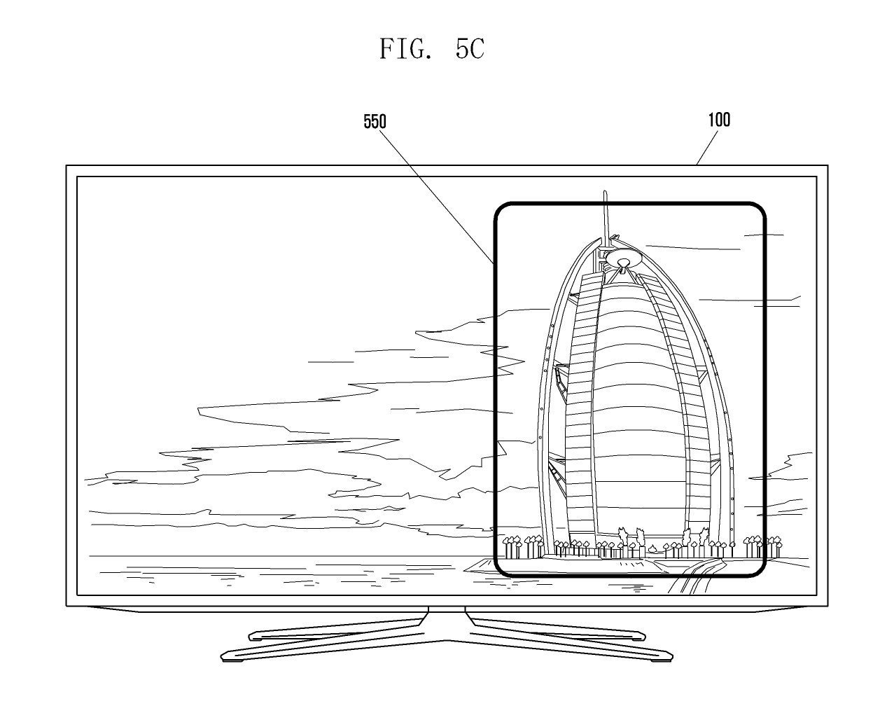

FIGS. 5A to 5C are diagrams of an example of a user interface, according to aspects of the disclosure.

Referring to FIG. 5A, a user who desires to obtain information about persons 510 and 520 contained in a visible output may command the electronic device 100 to acquire an image containing the desired objects. Then the electronic device 100 transmits the acquired image to the server 200, and the server 200 analyzes the acquired image. Namely, the server 200 may extract the objects 510 and 520, indicating persons, from the acquired image and create an analysis result about the extracted objects by comparing the extracted objects 510 and 520 against a database of known facial images (or image signatures). Then the server 200 transmits the created analysis result to the electronic device 100, and the electronic device 100 may revise or supplement the received analysis result with information about the persons 510 and 520. Then the electronic device 100 may transmit the revised or supplemented analysis result about the persons 510 and 520 to the server 200, and the server 200 may update the created and stored analysis result according to the revised or supplemented analysis result. Additionally or alternatively, when any acquired image containing therein the persons 510 and 520 as objects is received from the electronic device 100, the server 200 may monitor user's preferences about the persons 510 and 520 and then apply such preferences to the analysis result.

Referring to FIG. 5B, a user who desires to obtain information about objects 530 and 540 may command the electronic device 100 to acquire an image containing the desired objects. Then the electronic device 100 transmits the acquired image to the server 200, and the server 200 analyzes the acquired image. Namely, the server 200 may extract the objects 530 and 540 from the acquired image and create an analysis result about the extracted objects by comparing the extracted objects 530 and 540 against a database of known images (or image signatures). Then the server 200 transmits the created analysis result to the electronic device 100, and the electronic device 100 may revise or supplement the received analysis result with information about the objects 530 and 540. Then the electronic device 100 may transmit the revised or supplemented analysis result about the objects 530 and 540 to the server 200, and the server 200 may update the created and stored analysis result according to the revised or supplemented analysis result. Additionally or alternatively, when any acquired image containing therein the objects 530 and 540 is received from the electronic device 100, the server 200 may monitor user's preferences about the objects 530 and 540 and then apply such preferences to the analysis result.

Referring to FIG. 5C, a user who desires to obtain information about a landmark 550 contained in video that is currently being played may command the electronic device 100 to acquire an image from the video an image (e.g., a video frame) that contains the landmark. Then, the electronic device 100 transmits the acquired image to the server 200, and the server 200 analyzes the acquired image. Namely, the server 200 may extract the object 550, indicating a landmark, from the acquired image and creates an analysis result about the extracted object by comparing the extracted object 550 with stored database of landmarks. Then the server 200 transmits the created analysis result to the electronic device 100, and the electronic device 100 may revise or supplement the received analysis result with information about the landmark 550. Then the electronic device 100 may transmit the revised or supplemented analysis result about the landmark 550 to the server 200, and the server 200 may update the created and stored analysis result according to the revised or supplemented analysis result. Additionally, when any acquired image containing therein the landmark 550 is received from the electronic device 100, the server 200 may monitor user's preferences about the landmark 550 and then apply such preferences to the analysis result.

As fully discussed hereinbefore, the electronic device and related method can simply provide an image-based search technique by acquiring a desired image from visible content being played.

The above-described aspects of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine-readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

It should further be noted that the FIGS. 1-5C are provided as examples only. At least some of the operations discussed with respect to those figures can be performed in a different order, performed concurrently, or altogether omitted. Although, the examples throughout the disclosure are provided in the in the context of a hearing aid device, it is to be understood that the concepts revealed in those examples can be applied to headphones, headsets, and/or any other suitable type of ear-wearable device. Although aspects of the disclosure have been provided in the context of video content, it will be clear that the concepts disclosed herein can be applied to still images, as well. Thus, in some implementations, information on objects depicted in still images may be provided in the manner discussed above. Although aspects of the disclosure have been described in detail hereinabove, it should be understood that many variations and modifications of the basic inventive concept described herein will still fall within the spirit and scope of the disclosure as defined in the appended claims.

While this disclosure has been particularly shown and described with reference specific examples thereof, it will be understood by those skilled in the art that various changes in form and details may be made therein without departing from the spirit and scope of this disclosure as defined by the appended claims.

What is claimed is:

1. A method comprising:
transmitting, by an electronic device, an image to a server, the image being part of a video content that is currently output by the electronic device;
receiving, from the server, at least one of analysis results that are generated by the server based on the image, each analysis result including a respective search query that is generated by the server and one or more search results retrieved by the server based on the respective search query;
displaying the received at least one analysis result.

2. The method of claim 1, wherein the image includes at least one object and the one or more search results include information about the object.

3. The method of claim 2, wherein the at least one object includes a face.

4. The method of claim 2, further comprising:
outputting, by the electronic device, an indication that the one or more search results are received;
detecting a first input instructing the electronic device to display the received at least one analysis result;
wherein the received at least one analysis result is displayed only after the first input is detected.

5. The method of claim 4, further comprising:
detecting a second input selecting the received at least one analysis result; and
displaying the selected at least one analysis result in response to the second input.

6. The method of claim 5, further comprising:
determining whether there is a revision or supplement of the at least one analysis result; and
if the analysis result is revised or supplemented, transmitting the revised or supplemented analysis result to the server.

7. An electronic device comprising a control unit configured to:
transmit an image to a server, the image being part of a video content that is currently output by the electronic device;
receive at least one of analysis results that are generated by the server based on the image, each analysis result including a respective search query that is generated by the server and one or more search results retrieved by the server based on the respective search query; and
display the received at least one analysis result.

8. The electronic device of claim 7, wherein the image includes at least one object and the one or more search results include information about the object.

9. The electronic device of claim 8, wherein the at least one object includes a face.

10. The electronic device of claim 8, wherein the control unit is further configured to:
output an indication that the one or more search results are received;
detect a first input instructing the control unit to display the received at least one analysis result;
wherein the received at least one analysis result is displayed only after the first input is detected.

11. The electronic device of claim 10, wherein the control unit is further configured to:
detect a second input selecting the received at least one analysis result; and
display the selected at least one analysis result in response to the second input.

12. The electronic device of claim 11, wherein the controller is further configured to determine whether there is a revision or supplement of the at least one analysis result; and if the analysis result is revised or supplemented, transmit the revised or supplemented analysis result to the server.

13. A server comprising a control unit configured to:
receive an image from an electronic device;
extract at least one object from an acquired image;
compare the object with a stored database of objects and retrieve, from the database, information that matches the object;
create an analysis result corresponding to the object; and
transmit the analysis result to the electronic device.

14. The server of claim 13, wherein the control unit is further configured to monitor a user's preference about a specific object contained in the acquired image when the acquired image is received from the electronic device, and to apply the user's preference to the analysis result.

15. The server of claim 14, wherein the control unit is further configured to:
receive an update to the analysis result from the electronic device; and
modify contents of the database based on the update.

16. An electronic device comprising a control unit configured to:
transmit an image to a server, the image being part of a video content that is currently output by the electronic device;
receive an analysis result that is generated by the server based on the image, the analysis result including a search query that is generated by the server and one or more search results retrieved by the server based on the search query; and
display the analysis result.

17. The electronic device of claim 16, wherein the image includes at least one object and the one or more search results include information about the object.

18. The electronic device of claim 16, wherein the at least one object includes a face.

19. The electronic device of claim 16, wherein the control unit is further configured to:
output an indication that the one or more search results are received;
detect a first input requesting the search result to be displayed;
wherein the one or more search results are displayed only when the first input is detected.
